(19) United States
(12) Patent Application Publication
(10) Pub. No.: US 2007/0140544 A1
(43) Pub. Date: Jun. 21, 2007

(54) Detection level calibration method and apparatus for counterfeit detectors

(76) Inventor: Ming-Hsun Liu, Taipei City (TW)

Correspondence Address: FRENKEL & ASSOCIATES, 3975 UNIVERSITY DR., STE. 330, FAIRFAX, VA, 22030, US

(21) Appl. No.: 11/300,937

(22) Filed: Dec. 15, 2005

(51) Int. Cl. G06K 9/00

(52) U.S. Cl. 382/137

(57) ABSTRACT

A detection level calibration method and an apparatus thereof for counterfeit detectors includes a recognition module in a counterfeit detector to scan and detect a calibration object fed into the counterfeit detector to get an actual recognition characteristic value. Through the actual recognition characteristic value, an actuation setting value of the recognition module is restored to a preset recognition characteristic value. Thereby the conventional manual fine-tuning calibration mode can be replaced by the automatic scanning recognition mode. Calibration process of the counterfeit detector can be performed more conveniently.

### FIELD OF THE INVENTION

The present invention relates to a detection level calibration method and apparatus for counterfeit banknote detectors and particularly to a method and an apparatus that perform detection level calibration through an automatically scanning mode via a calibration object.

### BACKGROUND OF THE INVENTION

In the financial market bank notes are circulated widely at a huge amount. Hence fake bank notes often become pursuing targets of unlawful gangsters. To thwart this threat, every country often tries to produce a dedicated bank note detection mechanism to weed out the fake bank notes. The commonly used mechanism is optical detection mode or magnetic flux detection mode. The design of counterfeit detectors generally is divided into hand-held type or standing type for detecting fake single currency or multiple currencies.

Whatever the detection technique adopted in the counterfeit detector, each producer of the counterfeit detector has its own specifications that are slightly different. Hence the machine has to go through a calibration process before being put to practical use. After the counterfeit detector has been used for a period of time, elements in the machine for detection wear out in varying degrees. Hence a periodical calibration is needed. Then erroneous detection could happen when performing detection of different currencies. The present level calibration techniques of the counterfeit detector mostly adopt mechanical type that is adjusted manually. The general users cannot do calibration process. In the manual calibration mode, the entire counterfeit detector has to be disassembled to perform the calibration process. This is tedious and time-consuming. Moreover, after the counterfeit detector has been assembled again, it often happens that the recognition module is not being installed correctly on the original location. This causes malfunction of the machine and erroneous detection. It creates a lot of troubles to users.

### SUMMARY OF THE INVENTION

Therefore the primary object of the present invention is to solve the aforesaid disadvantages. The present invention provides an automatic scanning recognition mode to substitute the conventional manual fine tuning calibration mode. By means of the invention, users can perform calibration process by themselves. The invention provides a calibration object that has a preset detection level to be input into a counterfeit detector to be scanned and detected by a recognition module to get an actual recognition characteristic value. The actual recognition characteristic value alters an actuation setting value of the recognition module to a preset recognition characteristic value. Then the elements inside the machine can automatically execute digital transformation to perform level calibration process.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is the flow chart of an embodiment of the present invention.

FIG. 2 is the flow chart of another embodiment of the present invention.

FIG. 3 is a perspective view of the counterfeit detector of the present invention.

FIG. 4 is a plane view of the calibration object of the present invention.

FIG. 5 is a schematic view of the counterfeit detector of the present invention in the calibration process.

FIG. 6 is a sectional view of the calibration object.

FIG. 7 is a schematic view of the recognition modules of the present invention in the calibration process.

### DETAILED DESCRIPTION OF THE PREFERRED EMBODIMENTS

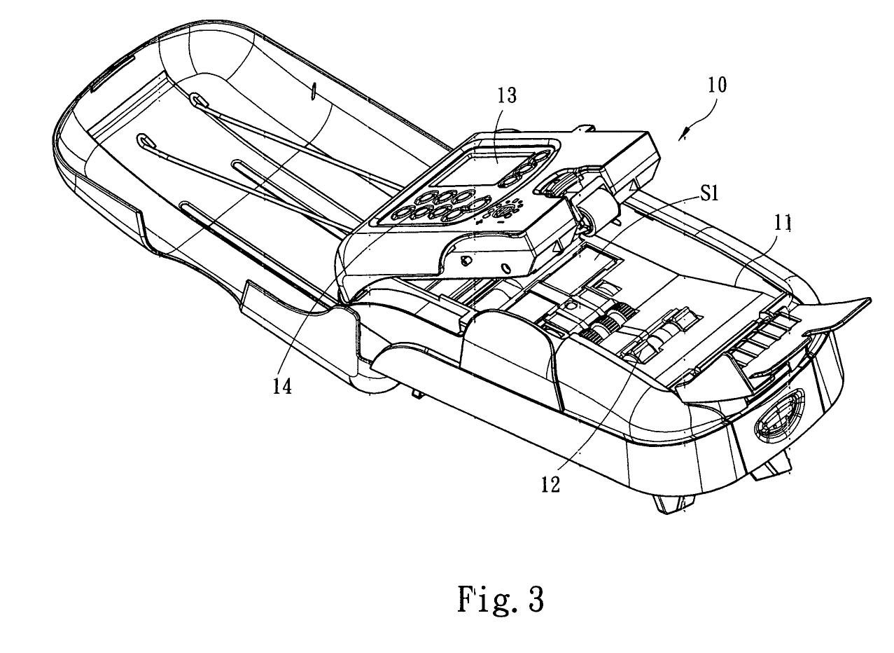

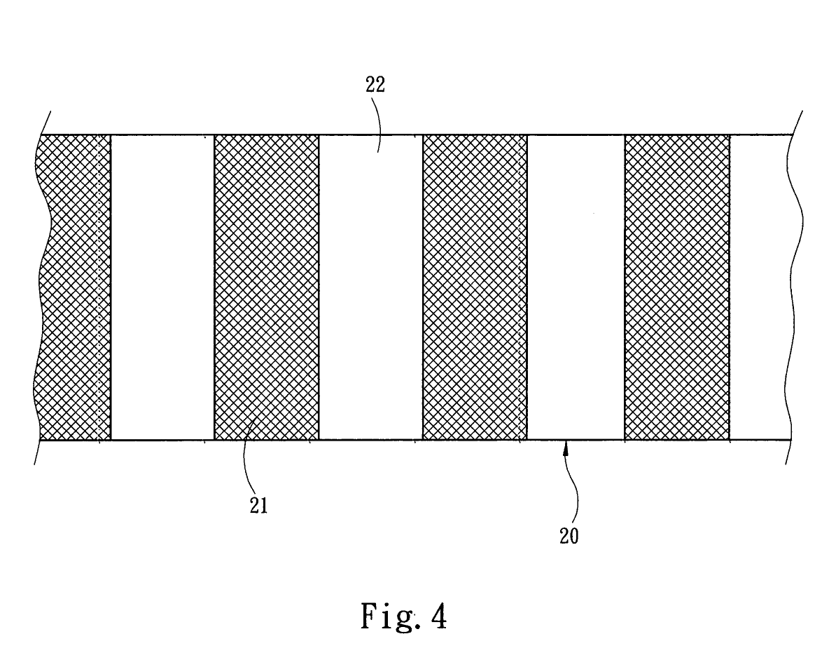

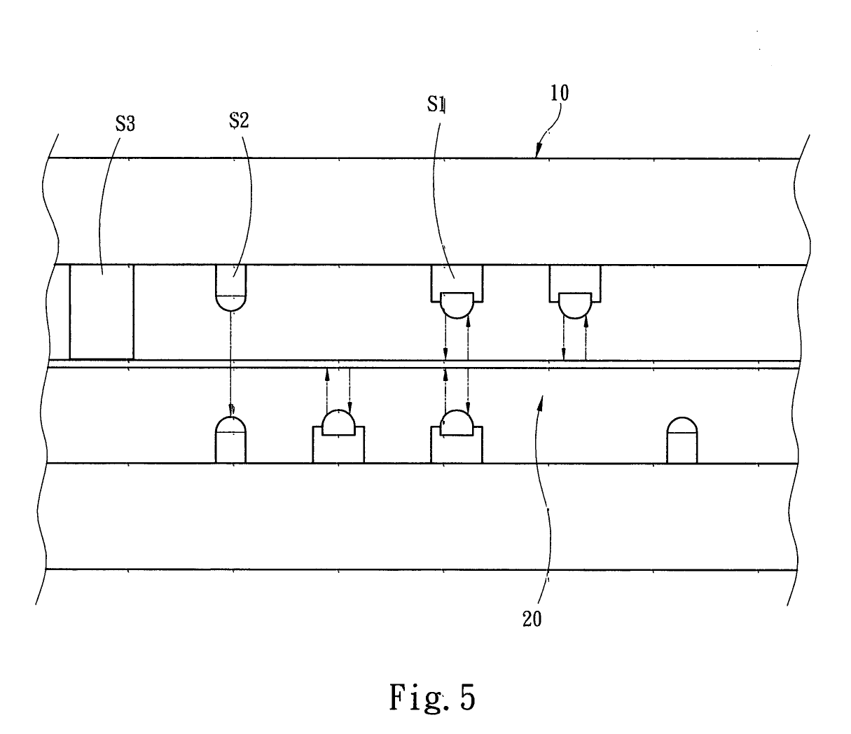

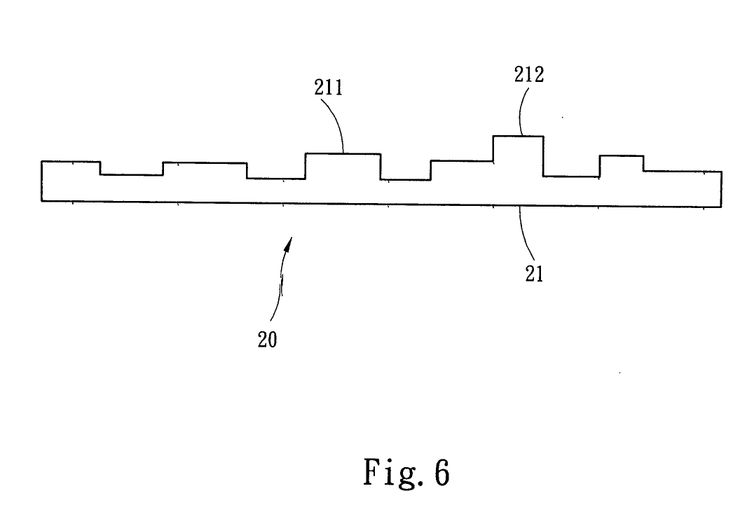

Please referring to FIGS. 3 through 7, the present invention aims to provide a detection level calibration apparatus for a counterfeit detector 10. The counterfeit detector 10 has a bank note passage 11 and a bank note conveying mechanism 12 corresponding to the bank note passage 11 to transport a calibration object 20 into the bank note passage 11. The counterfeit detector 10 also has recognition modules S1, S2 and S3 to generate induction for bank notes passing through the bank note passage 11. The recognition modules S1, S2 and S3 may be optical detectors, magnetic detectors or combinations thereof. The counterfeit detector 10 further has a display screen 13 to display conditions of the recognition modules S1, S2 and S3, and a calibration and operation zone 14. The main feature of the invention is the calibration object 20 which can be fed into the bank note passage 11 and detected by the recognition modules S1, S2 and S3. The calibration object 20 has induction zones 21 which have a preset detection level. In an embodiment of the invention, the calibration object 20 has the induction zones 21 and blank zones 22 spaced from each other. Depending on different detection characteristics of the recognition modules S1, S2 and S3, the induction zones 21 are formed by printing with ink on one or both surfaces of the calibration object 20 in response to the detection wavelength of different optical detectors. Referring to FIG. 6, the induction zones 21 consist of a plurality of induction layers 211 and 212 of varying thickness. In response to the magnetic detectors, the induction zones 21 are formed by printing with metalic material so that the recognition modules S1, S2 and S3 can detect the induction zones 21 and update actuation setting values of the recognition modules S1, S2 and S3.

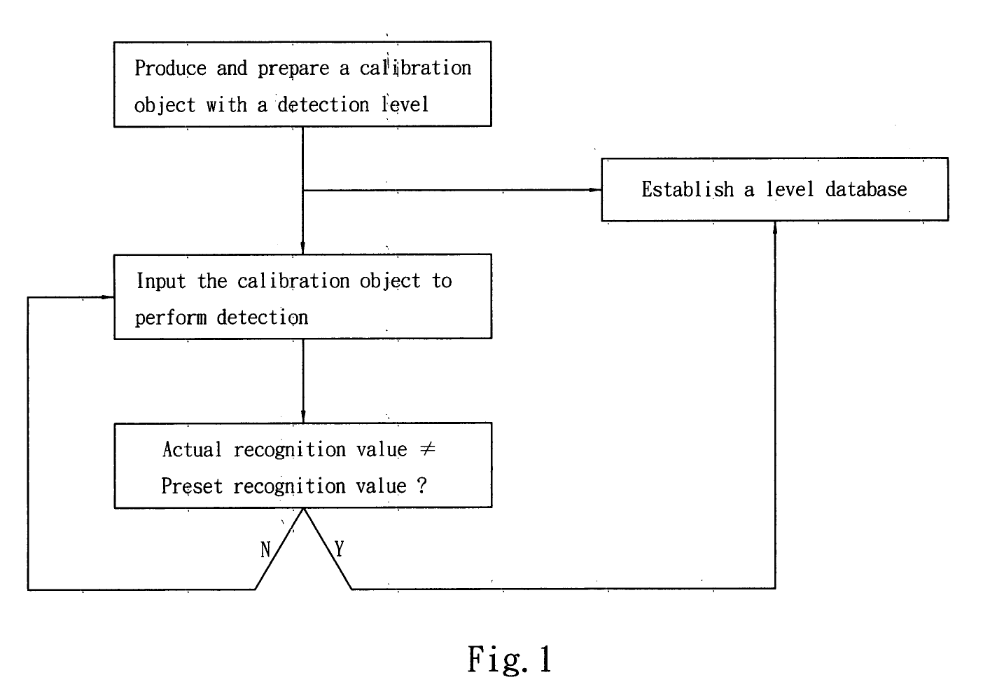

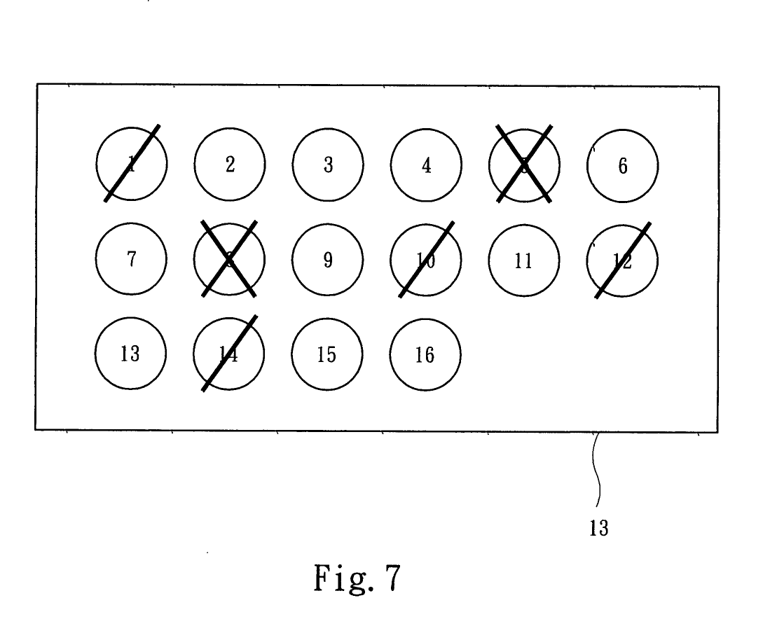

Also referring to FIG. 1, when the counterfeit detector 10 is shipped or being used for a period of time and level error occurs, users can perform level calibration by means of the recognition modules S1, S2 and S3. First, fabricate and prepare the calibration object 20 with a detection level corresponding to a preset recognition characteristic value generated by the recognition modules S1, S2 and S3 in the counterfeit detector 10. And a level database is set up in advance in the counterfeit detector 10. The level database, based on an actual recognition characteristic value generated according to the detection level, establishes actuation setting values of the recognition modules S1, S2 and S3 to restore the preset recognition characteristic value. When users, through the calibration and operation zone 14, set the counterfeit detector 10 to process calibration and input the calibration object 20 to perform detection, the display screen 13 displays the number of the recognition modules S1, S2 and S3. When the calibration object 20 enters the counterfeit detector 10 and is detected by the recognition modules S1, S2 and S3 for the detection level, the actual recognition characteristic value is generated. In the event that the actual recognition characteristic value is same as the preset recognition characteristic value, return to the previous step. In the event that the actual recognition characteristic value is different from the preset recognition characteristic value, the actual recognition characteristic value is mapped against the level database to get the actuation setting values of the recognition modules S1, S2 and S3 to restore the correct preset recognition characteristic value for the recognition modules S1, S2 and S3 in the counterfeit detector 10. The detection level is laid on the calibration object 20 in a spaced manner. During the detection process multiple sets of the actual recognition characteristic value are generated. And an average actual recognition characteristic value is derived by processing. Based on different characteristics of the recognition modules S1, S2 and S3, the detection level may be magnetic flux or photosensitive energy. Referring to FIG. 7, the display screen 13 displays the condition after calibration of the recognition modules S1, S2 and S3 has been performed. The symbol “X” for the recognition modules S1, S2 and S3 shown on the display screen 13 indicates that the actual recognition characteristic value exceeds the maximum setting value in the level database, and the marked recognition modules S1, S2 and S3 are damaged and have to be replaced. The symbol “/” for the recognition modules S1, S2 and S3 shown on the display screen 13 indicates that the recognition modules S1, S2 and S3 could be deviated when the calibration object 20 is input and determination cannot be done effectively, or error occurs to the level calibration. Then users can re-do input of the calibration object 20 to continue the calibration process to get the accurate level for all of the recognition modules S1, S2 and S3.

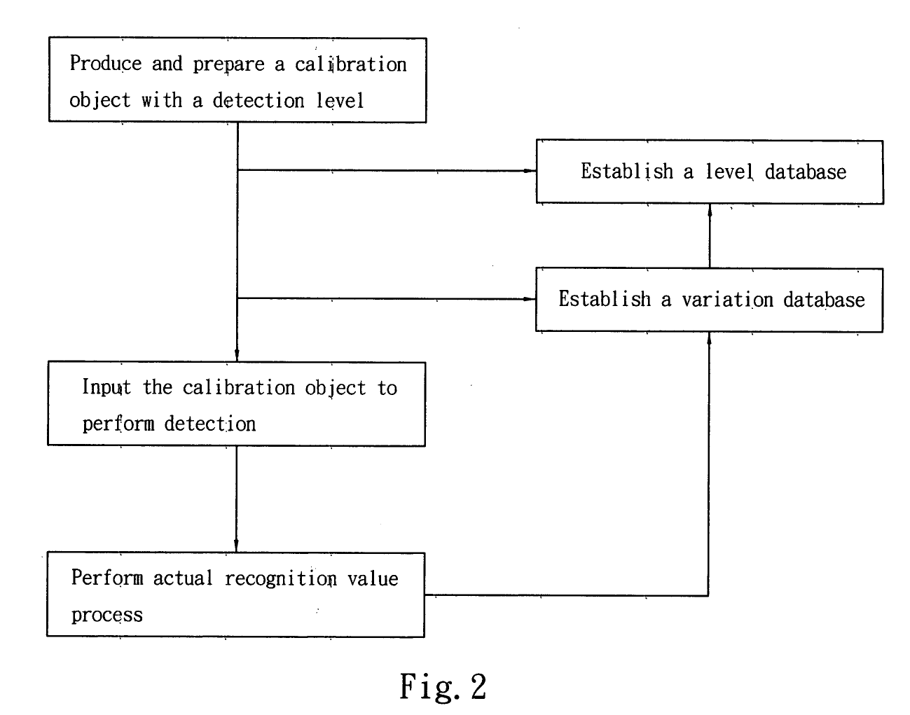

Refer to FIG. 2 for another embodiment of the invention corresponding to a different software design. It also starts by preparing the calibration object 20 with a detection level formed thereon. However, the interior of the counterfeit detector 10 establishes a level database for setting up the actuation setting values of the recognition modules S1, S2 and S3 based on the preset recognition characteristic value generated according to the detection level, and establishes a variation database for setting up the actuation setting values of the recognition modules S1, S2 and S3 based on the actual recognition characteristic value generated according to the detection level. When the calibration object 20 enters the counterfeit detector 10 and is detected, the actual recognition characteristic value is mapped against the variation database to get a new actuation setting value for the recognition modules S1, S2 and S3; then a replacing mode or variation process mode is employed to update the level database, and the level database is processed and updated through the variation database to restore the actuation setting values corresponding to the correct preset recognition characteristic value for the recognition modules S1, S2 and S3 in the counterfeit detector 10. In order to achieve correct level calibration, after the update process the level database has been finished, the calibration object 20 may be input repeatedly to perform the detection process to get a more accurate and updated level database. Or the detection level is laid on the calibration object 20 in a spaced manner, and multiple sets of the actual recognition characteristic value are generated during the detection process. Each time the actual recognition characteristic value is generated, a process is done to update the level database. Or an average actual recognition characteristic value is derived by calculation to perform the process. Whatever the process of the software design, the calibration object 20 can be used to perform level calibration process for the recognition modules S1, S2 and S3 without disassembling the counterfeit detector 10. And the conditions of the recognition modules S1, S2 and S3 can be displayed on the display screen 13 to enable users to recognize and determine whether the recognition modules S1, S2 and S3 are no longer usable and require replacement.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A detection level calibration method for counterfeit detectors, comprising:
producing and preparing a calibration object which has a detection level formed according to a preset recognition characteristic value generated by a recognition module which recognizes bank notes in a counterfeit detector;
establishing a level database of an actuation setting value of the recognition module based on an actual recognition characteristic value generated according to the detection level to restore the preset recognition characteristic value; and
entering the calibration object into the counterfeit detector to be detected by the recognition module for the detection level and generating the actual recognition characteristic value, the actual recognition characteristic value being mapped against the level database to get the recognition module actuation setting value to allow the recognition module of the counterfeit detector to restore the correct preset recognition characteristic value.

2. The detection level calibration method of claim 1, wherein the detection level is laid on the calibration object in a spaced manner, and the detection process generates multiple sets of the actual recognition characteristic value that are processed to derive an average actual recognition characteristic value.

3. The detection level calibration method of claim 1, wherein the recognition module is a magnetic detector and the detection level is magnetic flux.

4. The detection level calibration method of claim 1, wherein the recognition module is an optical detector and the detection level is photosensitive energy.

5. A detection level calibration method for counterfeit detectors, comprising:
producing and preparing a calibration object which has a detection level formed according to a preset recognition characteristic value generated by a recognition module which recognizes bank notes in a counterfeit detector;
establishing a level database of an actuation setting value of the recognition module based on a preset recognition characteristic value generated according to the detection level;
establishing a level database based on an actual recognition characteristic value generated according to the detection level to establish the level database of the actuation setting value of the recognition module,
entering the calibration object into the counterfeit detector to be detected by the recognition module for the detection level and generating the actual recognition characteristic value, the actual recognition characteristic value being mapped against the variation database to get a new recognition module actuation setting value; and
updating the level database through a replacing mode or a variation processing mode to update the level database by processing the variation database to restore the actuation setting value of the recognition module in the counterfeit detector corresponding to the correct preset recognition characteristic value.

6. The detection level calibration method of claim 5, wherein the step of updating the level database is followed by repetitive execution of the entering the calibration object to get a more accurate new level database.

7. The detection level calibration method of claim 5, wherein the detection level is laid on the calibration object in a spaced manner and the detection process generates multiple sets of the actual recognition characteristic value that are processed to update the level database.

8. The detection level calibration method of claim 5, wherein the detection level is laid on the calibration object in a spaced manner and the detection process generates multiple sets of the actual recognition characteristic value that are processed to derive an average actual recognition characteristic value.

9. The detection level calibration method of claim 5, wherein the recognition module is a magnetic detector and the detection level is magnetic flux.

10. The detection level calibration method of claim 5, wherein the recognition module is an optical detector and the detection level is photosensitive energy.

11. A detection level calibration apparatus for counterfeit detectors, comprising:
a counterfeit detector which has a bank note passage and a recognition module corresponding to the bank note passage to detect bank notes passing through the bank note passage; and
a calibration object to be input into the bank note passage and detected by the recognition module having an induction zone which has a preset detection level to be detected by the recognition module to update an actuation setting value of the recognition module.

12. The detection level calibration apparatus of claim 11, wherein the counterfeit detector has a bank note conveying mechanism corresponding to the bank note passage to transport the calibration object in the bank note passage.

13. The detection level calibration apparatus of claim 11, wherein the induction zone is spaced from a blank zone on the calibration object.

14. The detection level calibration apparatus of claim 11, wherein the induction zone is formed by printing with ink.

15. The detection level calibration apparatus of claim 11, wherein the recognition module is an optical detector.

16. The detection level calibration apparatus of claim 15, wherein the recognition module includes a plurality of optical detectors, the induction zone having a plurality of induction layers of different thickness corresponding to different detection wavelengths of the optical detectors.

17. The detection level calibration apparatus of claim 11, wherein the recognition module is a magnetic detector, and the induction zone is formed by printing with a metalic ink.

18. The detection level calibration apparatus of claim 11, wherein the recognition module consists of a magnetic detector and an optical detector.

19. The detection level calibration apparatus of claim 11, wherein the counterfeit detector further has a display screen to display conditions of the recognition module and a calibration and operation zone.

20. The detection level calibration apparatus of claim 11, wherein the induction zone is formed on at least one surface of the calibration object.
